(19) United States
(12) Patent Application Publication
(10) Pub. No.: US 2014/0157368 A1
(43) Pub. Date: Jun. 5, 2014

(54) SOFTWARE AUTHENTICATION

(71) Applicants: Srujal SHAH, Naperville, IL (US); John H. Haller, Naperville, IL (US); Daniel Johnson, Aurora, IL (US); Lyle D. Kipp, Naperville, IL (US); Manish K. Sharma, Branchbug, NJ (US); Richard L. Sohn, Lisle, IL (US)

(72) Inventors: Srujal SHAH, Naperville, IL (US); John H. Haller, Naperville, IL (US); Daniel Johnson, Aurora, IL (US); Lyle D. Kipp, Naperville, IL (US); Manish K. Sharma, Branchbug, NJ (US); Richard L. Sohn, Lisle, IL (US)

(21) Appl. No.: 13/705,818

(22) Filed: Dec. 5, 2012

(51) Int. Cl. H04L 29/06

(52) U.S. Cl. CPC H04L 63/08
USPC 726/4

(57) ABSTRACT

According to an embodiment, a computing system includes a server configured to provide an authentication indicator to least one software application for enabling the software application to provide at least one computing feature. The authentication indicator is generated based on at least two identifiers that are distinct from a hardware identifier of a device on which a software application is running

### BACKGROUND

Software is typically provided to an end user under the terms of a license. The ability of the end user to use the software typically depends on verification of the software license. For example, it is common practice for a system identifier to be derived from a unique characteristic of the hardware upon which the software application will be running and to associate that with a software license key provided by the software vender. The hardware identifiers typically have been the chassis serial number or MAC address. With this approach, the software license key is useable for running that software on that particular hardware.

If one were to attempt to copy the software and then use it on another machine, the license key will not work because the other machine will not have the appropriate hardware identifier. With such an approach, even if a copy of the software were made, it will not be useful because it requires authentication of an appropriate license key before important features of the software will be activated or available to an end user.

Changes in computing practices, such as the increased use of cloud computing services, introduce new challenges for preventing unauthorized use or copying of software.

### SUMMARY

According to an example embodiment, a computing system includes a server configured to provide an authentication indicator to least one software application for enabling the software application to provide at least one computing feature. The authentication indicator is generated based on at least two identifiers. The two identifiers are distinct from a hardware identifier of a device on which the application is running

According to one embodiment, the two identifiers are selected from an Internet Protocol address of the device, a domain name associated with the device, a customer identifier associated with the device or metadata associated with the device.

According to an example embodiment, a computing method includes generating an authentication indication based on at least two identifiers. The two identifiers are distinct from a hardware identifier of a device on which the application is running. The authentication indication is provided to the software application for enabling the software application to provide at least one computing feature.

The various features and advantages of at least one disclosed example embodiment will become apparent to those skilled in the art from the following detailed description. The drawings that accompany the detailed description can be briefly described as follows.

### BRIEF DESCRIPTION OF THE DRAWINGS

FIG. 1 schematically illustrates a computing system designed according to an embodiment of this invention.

FIG. 2 schematically illustrates an authentication technique useful with the example embodiment of FIG. 1.

FIG. 3 schematically illustrates a heartbeat verification technique useful with the example embodiment of FIG. 1.

### DETAILED DESCRIPTION

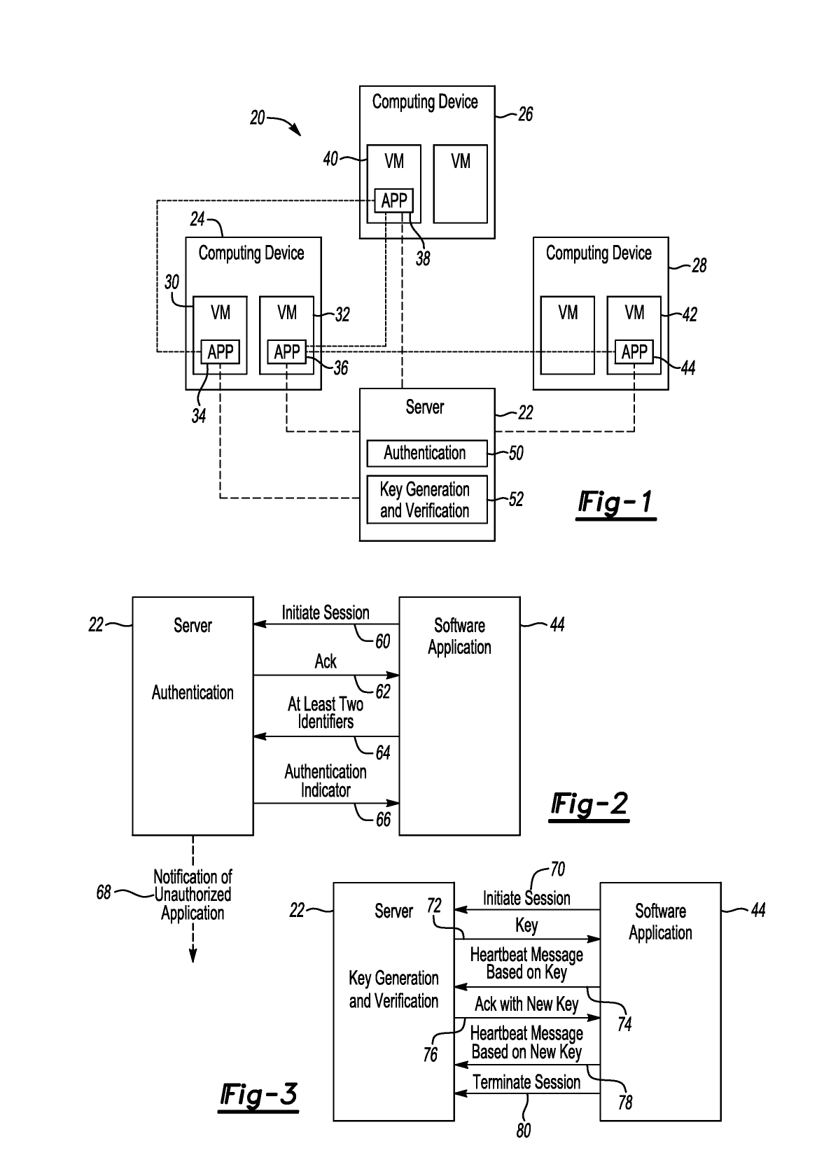

FIG. 1 schematically shows selected portions of a computing system 20. A server 22 includes at least one processor that is configured to manage or control at least some computing operations performed by one or more users utilizing computing devices 24, 26 and 28. In this example, the computing devices 24, 26 and 28 are part of a cloud computing system. The computing devices provide resources to one or more users of the cloud computing system according to an agreement between a cloud service provider and the users. For example, the computing devices in some examples are network elements that provide services within an IP Multimedia Subsystem network.

In the illustrated example, the computing device 24 is illustrated with a virtual machine (VM) instance 30 and another virtual machine instance 32. In this example, at least one software application (APP) 34 is running on the virtual machine instance 30 and another software application 36 is running on the virtual machine instance 32. Another software application 38 is running on a virtual machine instance 40 on the computing device 26. A virtual machine instance 42 on the computing device 28 includes another software application 44.

The server 22 communicates with each of the software applications for maintaining control over use of those applications. In one embodiment, the server 22 is configured to process orders from customers desiring to use software applications. The server 22 includes an authentication module 50 that allows the server 22 to provide an authentication indicator, which may be referred to as a license key in some embodiments, to each of a plurality of the software applications. The server 22 includes data storage, for example, including computer executable instructions for at least one technique for generating an authentication indicator for any one of the software applications.

The example of FIG. 1 includes an additional feature for enhancing security and control over the use of software applications. The server 22 includes a key generation and verification module 52 that is useful for communicating with software applications on an ongoing basis for at least periodically verifying the authenticity of an application

The authentication indicator for a software application in this example is based on at least two identifiers. At least one of the identifiers may be associated with a device on which the application is running. The other identifier may be associated with another software application that cooperates with the software application for which an authentication indicator is needed. The two identifiers are distinct from a hardware identifier of the device.

In an example embodiment, the two identifiers used for the authentication indicator are selected from an Internet Protocol address of the device on which the application is running, a domain name associated with the device on which the application is running, a customer identifier associated with the device and metadata associated with the device. Other identifiers may be used. For example, the identifier may be associated with another software application or a device upon which that other application is running. Examples of such identifiers include the IP address or domain name of the other application. There are other identifiers that will become apparent to those skilled in the art that have the benefit of this description and an authentication indicator consistent with the teachings of this description can be based on such other identifiers. The identifiers upon which the authentication indicator is based are distinct from a hardware identifier like a MAC address or a chassis serial number.

In a virtualized environment, such as a cloud computing system, software applications run on a virtual machine that presents an abstracted representation of the underlying hardware. Accordingly, the authentication indicator of this description allows for authorized use of software applications without tying that authorization to a particular piece of hardware or an identifier of the hardware. At the same time, the authentication indicator of this example prevents unauthorized copying or use of a software application.

In a cloud computing arrangement such as that schematically shown in FIG. 1, it is possible for one or more of the applications to be running on one or more of the virtual machine instances that is different during one computing session compared to another. Utilizing an authentication indicator that includes identifiers distinct from a hardware identifier allows for authorized use of the software application on more than one computing device.

Including a combination of two identifiers within the authentication indicator increases the likelihood that the indicator will be unique even if the individual identifiers, themselves, are not unique. The combination of the combined two identifiers has an increased likelihood of being unique for purposes of enabling application features or capacity. In one example, the server 22 is configured to know which identifiers are expected from a particular application or type of application. The server 22 is programmed or otherwise configured to use a predetermined algorithm for developing or generating an authentication indicator. In one example, the identifier information from a software application is combined using a technique, such as a secure hash (e.g., SHA-1) across the concatenation of the identifiers. The authentication indicator in most implementations will not be recognizable by any unauthorized devices or applications and will not be subject to analysis that would reveal the underlying identifiers without appropriate knowledge of the algorithm used to generate the authentication indicator.

An attempt to copy or otherwise use an application in an unauthorized manner by manipulating an authentication indicator would require that the identifiers used as a basis of the authentication indicator would have to have multiple appearances within the application's operational scope, which would be detectable as an error by external applications.

While the example of FIG. 1 is described as a cloud computing environment, the disclosed technique of using an authentication indicator that includes two identifiers that are distinct from a hardware identifier may be used in more traditional computing environments in place of using a hardware identifier-based license authorization technique.

FIG. 2 schematically illustrates an authentication technique useful with the illustrated embodiment. The software application 44 is used as an example for discussion purposes in FIG. 2. At 60, the software application initiates a session with the server 22. Although FIG. 2 schematically shows direct communication between the server 22 and the application 44, there may be one or more intermediary devices or entities involved in the illustrated process. At 62, the server 22 provides an acknowledgement to the software application 44. At 64, the software application 44 provides the identifiers that will serve as the basis of the authentication indicator to the server 22. The identifiers are distinct from a hardware identifier of a device upon which the application is running The server 22 has an expectation of what the identifiers should be based, for example, on a previously placed order for user access to the software application 44. Assuming that the identifiers correspond to the expected identifiers, at 66, the server provides the authentication indicator to the software application 44.

The software application 44 can then use the authentication indicator for enabling one or more features or functionalities so that they are available to one or more users. The software application 44 in one example continues to use the authentication indicator over time to verify that the application is valid as a prerequisite for being enabled for one or more computing purposes. The authentication indicator may have a time limit or at least one other parameter that is useful for controlling the validity of the software application that received and uses the authentication indicator.

In the event that the identifiers received from the software application at 64 are not valid, the server 22 in this example provides a notification of an unauthorized application at 68. In some examples, the notification at 68 is communicated to the application, which is configured to limit any further access by any users or to otherwise disable at least some functionality of the application. The notification at 68 also may be provided in a variety of formats to one or more entities, such as the cloud service provider or the software vendor, for purposes of alerting an appropriate entity of potential unauthorized software copying or misuse.

For example, assume that application 44 provides an identifier corresponding to the public IP address or domain name of the application 38 as one of the identifiers at 64 in FIG. 2. If there was an attempt to make a clone of application 44, the cloned application 44 will have logic, which determines its own system ID (i.e., at least two identifiers as described above) based on another supposed to correspond to application 38. When this cloned version of application 44 requests a new authorization indicator, the server 22 will generate an alert at 68 because the request to generate the authorization indicator does not correspond to an order from the appropriate order management system.

The authorization indicator described above may also be used as a prerequisite for enabling cooperation between software applications, which may be, for example, part of an element management system or a database server system. In the illustrated example, one or more of the software applications communicates with one or more others of the applications for performing one or more computing operations. The software applications in the illustrated example provide an authentication indicator as a prerequisite for communications between the software applications. When an appropriate authentication indicator is provided by one of the software applications, such as the application 38, the software applications 34 and 36 will communicate with the software application 38. If the software application 38 does not provide an appropriate or valid authentication indicator, the software applications 34 and 36 in this example will not communicate with the application 38.

FIG. 3 schematically illustrates an example technique useful for ongoing verification of a software application, such as the software application 44. A handshaking or heartbeat monitoring session is initiated at 70. At 72, the server 22 provides a key to the software application 44. The software application responds at 74 with a heartbeat message that is based on the key. The heartbeat message may include the key or otherwise include information or an indication that is based on the key provided at 72. The server 22 verifies whether the heartbeat message is appropriate depending on whether it includes or is based on the correct key.

Assuming that an appropriate heartbeat message was received from the software application 44, the server 22 provides an acknowledgment and a new key at 76. The acknowledgement and the new key may be sent separately. The new key generated by the server 22 is different than the most recently provided key. The new key is used at 78 for a subsequent heartbeat message from the software application 44. The heartbeat message at 78 may be provided at a preselected time following the heartbeat message at 74 or the receipt of the new key at 76.

In the illustrated example, the server 22 verifies that the heartbeat message contains appropriate information, such as being based upon the correct key, each time that a heartbeat message is received by the server 22. Providing a new key for each subsequent heartbeat message ensures that the software application 44 remains in sync with the server 22. In one example, each new key is created using a random number generating process. The heartbeat message and key exchange continues on a predetermined schedule until the software application 44 terminates the session at 80.

At any time during the process schematically shown in FIG. 3, if the heartbeat message from the software application is invalid or does not contain appropriate information, the server 22 may provide an indication of a potential corruption of the software application 44, potential copying of the software application, potential unauthorized use or a combination of these.

The disclosed example techniques facilitate controlling use of software applications that allow for the applications to be used in a cloud computing environment, for example, while providing protection against unauthorized copying or use of software applications.

The preceding description is illustrative rather than limiting in nature. Variations and modifications to the disclosed examples may become apparent to those skilled in the art. The scope of legal protection can only be determined by studying the following claims.

1. A computing system, comprising:
a server configured to provide an authentication indicator to least one software application for enabling the software application to provide at least one computing feature, the authentication indicator being generated with a content of the authentication indicator based on at least two identifiers that are distinct from a hardware identifier of a device on which the software application is running.

2. The system of claim 1, wherein the at least two identifiers are selected from
an Internet Protocol address of the device,
a domain name associated with the device,
a customer identifier associated with the device,
metadata associated with the device,
an Internet Protocol address associated with another application, and
a domain name associated with another application.

3. The system of claim 1, wherein the device is part of a cloud computing system.

4. The system of claim 3, wherein the application is running on at least one virtual machine instance on the device.

5. The system of claim 1, wherein the device comprises a plurality of computing devices.

6. The system of claim 1, wherein the software application utilizes the authentication indicator for confirming that the software application is valid.

7. The system of claim 1, comprising a plurality of applications that communicate with each other, the at least one software application controlling communications with a second one of the applications based on whether the second one of the applications provides a valid authentication indicator.

8. The system of claim 1, wherein the server is configured to:
provide the application with a key on a preselected schedule; and
verify an authenticity of the application based on whether the application provides a heartbeat message to the server that includes an indication based on the key.

9. The system of claim 8, wherein
each key provided by the server is different than a most recently provided key; and
the server provides an indication that the application is not authentic if the heartbeat message from the application does not include a proper indication based on the key.

10. The system of claim 9, wherein the server is configured to generate at least some of the keys using a random number generation process.

11. A computing method, comprising:
generating an authentication indicator having a content based on at least two identifiers that are distinct from a hardware identifier of a device on which a software application is running; and
providing the authentication indicator to the software application for enabling the software application to provide at least one computing feature.

12. The method of claim 11, wherein the at least two identifiers are selected from
an Internet Protocol address of the device,
a domain name associated with the device,
a customer identifier associated with the device,
metadata associated with the device,
an Internet Protocol address associated with another application, and
a domain name associated with another application.

13. The method of claim 11, wherein the device is part of a cloud computing system.

14. The method of claim 13, comprising running the software application on at least one virtual machine instance on the device.

15. The method of claim 11, wherein the device comprises a plurality of computing devices.

16. The method of claim 11, comprising the software application using the authentication indicator for confirming that the software application is valid.

17. The method of claim 11, comprising
communicating between the at least one software application and at least a second application;
the at least one software application controlling communications with the second application based on whether the second application provides a valid authentication indicator; and
the second application controlling communications with the at least one software application based on whether the application provides a valid authentication indicator.

18. The method of claim 11, comprising:
providing the application with a key on a preselected schedule; and
verifying an authenticity of the application based on whether the application provides a heartbeat message to the server that includes an indication based on the key.

19. The method of claim 18, comprising
generating a new key that is different than a most recently provided key;
providing the new key to the application; and
providing an indication that the application is not authentic if the heartbeat message from the application does not include a proper indication of the provided new key.

20. The method of claim 19, comprising generating at least the new key using a random number generation process.

21. The method of claim 11, comprising
using a predetermined algorithm for generating the authentication indicator; and
using the two identifiers as an input to the predetermined algorithm.

22. The method of claim 21, wherein the predetermined algorithm includes using a concatenation of the two identifiers.

23. The method of claim 11, wherein
at least a portion of the two identifiers are within the authentication indicator;
at least a portion of the two identifiers are used for the authentication indicator; or
the authentication indicator includes at least a portion of the two identifiers.

24. The computing system of claim 1, wherein
the server is configured to use a predetermined algorithm for generating the authentication indicator; and
the server is configured to use the two identifiers as an input to the predetermined algorithm.

25. The computing system of claim 24, wherein the predetermined algorithm includes using a concatenation of the two identifiers.

26. The computing system of claim 1, wherein
at least a portion of the two identifiers are within the authentication indicator;
at least a portion of the two identifiers are used for the authentication indicator; or
the authentication indicator includes at least a portion of the two identifiers.
